(19) United States
(12) Patent Application Publication
(10) Pub. No.: US 2010/0265832 A1
(43) Pub. Date: Oct. 21, 2010

(54) METHOD AND APPARATUS FOR MANAGING A SLOW RESPONSE ON A NETWORK

(76) Inventors: PARITOSH BAJPAY, Edison, NJ (US); Chee Ching, Holmdel, NJ (US); Scott Corbin, Lewisville, TX (US); Luis Figueroa, Spotswood, NJ (US); Paul D. Gilbert, McKinney, TX (US); Monowar Hossain, Middletown, NJ (US); Thiru Ilango, Holmdel, NJ (US); David H. Lu, Morganville, NJ (US); Peter R. Wanda, Orlando, FL (US); Chen-Yui Yang, Marlboro, NJ (US)

Correspondence Address: AT & T LEGAL DEPARTMENT - WT, PATENT DOCKETING, ROOM 2A-207, ONE AT& T WAY, BEDMINSTER, NJ, 07921, US

(21) Appl. No.: 12/424,910

(22) Filed: Apr. 16, 2009

(51) Int. Cl. H04J 1/16

(52) U.S. Cl. 370/250

(57) ABSTRACT

A method and an apparatus for detection and prevention of a slow response on a network are disclosed. For example, the method selects a router automatically for testing in response to a ticket indicating a slow response, and performs a diagnostic test on the router, wherein the diagnostic test comprises at least one of: a protocol diagnostic test, a circuit diagnostic test or, a congestion diagnostic test. The method then performs at least one remedial step to address a root cause that is identified by the diagnostic test, wherein the root cause is associated with the slow response.

The present invention relates generally to communication networks and, more particularly, to a method and apparatus for providing detection and prevention of a slow response on a network such as a packet network, e.g., an Internet Protocol (IP) network, Asynchronous Transfer Mode (ATM) network, a Frame Relay (FR) network, and the like.

### BACKGROUND OF THE INVENTION

Today, networks are expected to have a reliable and predictable performance level. For example, customers who subscribe to voice, video and data services may have a service level agreement with the service provider specifying performance parameters such as packet loss rate, delay through the network, etc. However, the detection of a problem and subsequent remedial steps are typically performed manually by network engineers or technicians. This manual approach is time consuming and costly.

### SUMMARY OF THE INVENTION

In one embodiment, the present invention discloses a method and an apparatus for detection and prevention of a slow response on a network. For example, the method selects a router automatically for testing in response to a ticket indicating a slow response, and performs a diagnostic test on the router, wherein the diagnostic test comprises at least one of: a protocol diagnostic test, a circuit diagnostic test or, a congestion diagnostic test. The method then performs at least one remedial step to address a root cause that is identified by the diagnostic test, wherein the root cause is associated with the slow response.

### BRIEF DESCRIPTION OF THE DRAWINGS

The teaching of the present invention can be readily understood by considering the following detailed description in conjunction with the accompanying drawings, in which:

FIG. 1 illustrates an exemplary network related to the present invention;

FIG. 2 illustrates an exemplary network in accordance with one embodiment of the current invention for detection and prevention of a slow response;

FIG. 3 illustrates a flowchart of a method for providing detection and prevention of a slow response;

FIG. 4 illustrates a flowchart of a method for performing a protocol test on a router;

FIG. 5 illustrates a flowchart of a method for performing a circuit trouble diagnostics test;

FIG. 6 illustrates a flowchart of a method for performing a congestion trouble diagnostics test; and

FIG. 7 illustrates a high-level block diagram of a general-purpose computer suitable for use in performing the functions described herein.

To facilitate understanding, identical reference numerals have been used, where possible, to designate identical elements that are common to the figures.

### DETAILED DESCRIPTION

In one embodiment, the present invention broadly discloses a method and apparatus for providing detection and prevention of a slow response. Although the present invention is discussed below in the context of IP networks, the present invention is not so limited. Namely, the present invention can be applied to other packet networks, e.g., Asynchronous Transfer Mode (ATM) networks, cellular networks, wireless networks, and the like.

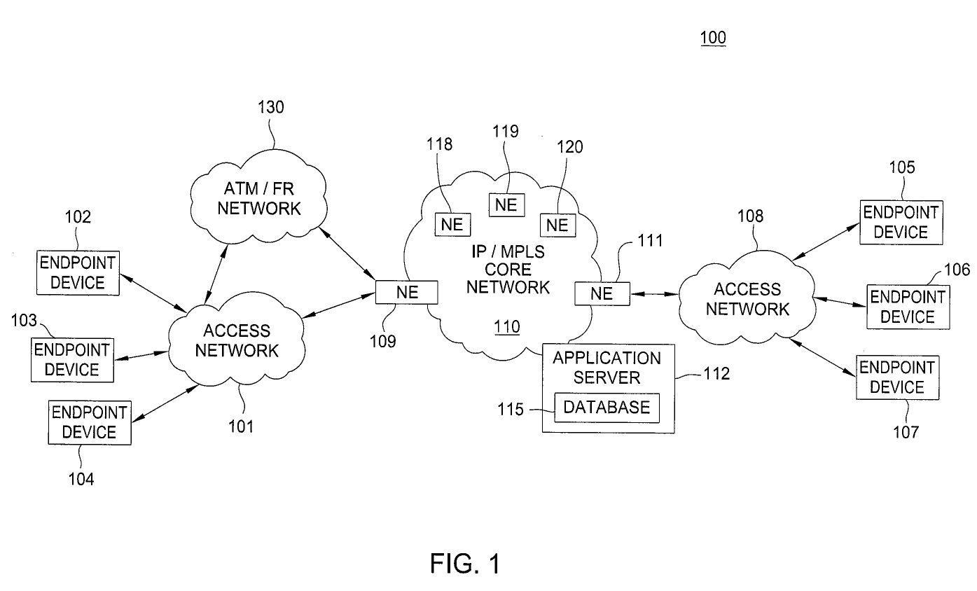

FIG. 1 is a block diagram depicting an exemplary packet network 100 related to the current invention. Exemplary packet networks include Internet Protocol (IP) networks, Asynchronous Transfer Mode (ATM) networks, Frame-Relay networks, and the like. An IP network is broadly defined as a network that uses Internet Protocol such as IPv4 or IPv6, and the like to exchange data packets.

In one embodiment, the packet network may comprise a plurality of endpoint devices 102-104 configured for communication with a core packet network 110 (e.g., an IP based core backbone network supported by a service provider) via an access network 101. Similarly, a plurality of endpoint devices 105-107 are configured for communication with the core packet network 110 via an access network 108. The network elements (NEs) 109 and 111 may serve as gateway servers or edge routers (e.g., broadly as a border element) for the network 110.

The endpoint devices 102-107 may comprise customer endpoint devices such as personal computers, laptop computers, Personal Digital Assistants (PDAs), servers, routers, and the like. The access networks 101 and 108 serve as a means to establish a connection between the endpoint devices 102-107 and the NEs 109 and 111 of the IP/MPLS core network 110. The access networks 101 and 108 may each comprise a Digital Subscriber Line (DSL) network, a broadband cable access network, a Local Area Network (LAN), a Wireless Access Network (WAN), and the like.

The access networks 101 and 108 may be either directly connected to the NEs 109 and 111 of the IP/MPLS core network 110 or through an Asynchronous Transfer Mode (ATM) and/or Frame Relay (FR) switch network 130. If the connection is through the ATM/FR network 130, the packets from customer endpoint devices 102-104 (traveling towards the IP/MPLS core network 110) traverse the access network 101 and the ATM/FR switch network 130 and reach the border element 109.

The ATM/FR network 130 may contain Layer 2 switches functioning as Provider Edge Routers (PERs) and/or Provider Routers (PRs). The PERs may also contain an additional Route Processing Module (RPM) that converts Layer 2 frames to Layer 3 Internet Protocol (IP) frames. An RPM enables the transfer of packets from a Layer 2 Permanent Virtual Connection (PVC) circuit to an IP network which is connectionless.

Some NEs (e.g., NEs 109 and 111) reside at the edge of the core infrastructure and interface with customer endpoints over various types of access networks. An NE that resides at the edge of a core infrastructure is typically implemented as an edge router, a media gateway, a border element, a firewall, a switch, and the like. An NE may also reside within the network (e.g., NEs 118-120) and may be used as a mail server, honeypot, a router, or like device. The IP/MPLS core network 110 may also comprise an application server 112 that contains a database 115. The application server 112 may comprise any server or computer that is well known in the art, and the database 115 may be any type of electronic collection of data that is also well known in the art. It should be noted that although only six endpoint devices, two access networks, and five network elements are depicted in FIG. 1, the communication system 100 may be expanded by including additional endpoint devices, access networks, network elements, or application servers without altering the scope of the present invention.

The above IP network is described to provide an illustrative environment in which packets for voice, data and multimedia services are transmitted on networks. For example, the service provider's network is expected to have a reliable and predictable performance level. One method of ensuring network performance level is to continuously monitor the network and to initiate remedial steps when a problem is detected. However, the detection and remedial steps are often performed by network engineers or technicians. For example, if a customer reports a slow network response, the service provider will create a ticket for the reported problem. A technician may then service the ticket by troubleshooting the reported problem to identify the root cause. After a lengthy and costly manual process to isolate the trouble, the technician may order remedial steps to be taken. Again, the remedial steps may also require another manual intervention by a technician.

In one embodiment, the current invention provides a method and apparatus for providing detection and prevention of a slow response on a network. For example, the method determines if the slow response is due to a congestion, a network degradation, and/or a trouble in routing protocol. The method then performs the diagnosis and any remedial steps in an automated manner.

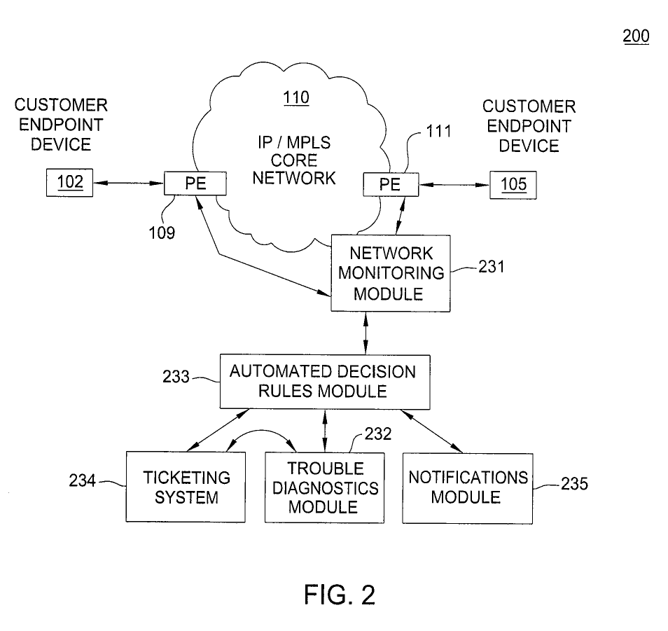

FIG. 2 illustrates an exemplary network 200 in accordance with one embodiment of the current invention for providing detection and prevention of a slow response. For example, the customer endpoint device 102 accesses network services in an IP/MPLS core network 110 via a Provider Edge (PE) router 109. Similarly, the customer endpoint device 105 accesses network services in the IP/MPLS core network 110 via a PE router 111. Traffic from the customer endpoint device 102 destined for the customer endpoint device 105 traverses the PE router 109 and the IP/MPLS core network 110 to reach PE router 111. Similarly, traffic from the customer endpoint device 105 destined for the customer endpoint device 102 traverses the PE router 111 and the IP/MPLS core network 110 to reach PE router 109.

In one embodiment, a network monitoring module 231 is connected to the routers in the IP/MPLS core network 110, e.g., PEs 109 and 111. The network monitoring module 231 is tasked with monitoring the status of the network, e.g., latency, packet loss, network availability, response time, etc. For example, the network monitoring module may then notify an application server 233 when it receives an alert from the various network devices. In turn, using the received notification(s), the service provider may implement a method for providing detection and prevention of a slow response in the application server 233 as further disclosed below.

In one embodiment, the application server 233 may contain an automated decision rules module for detecting and preventing a slow response. The application server 233 may also be connected to a ticketing system 234, a trouble diagnostics module 232 and a notifications module 235. For example, the application server 233 may utilize the ticketing system 234 for opening tickets, thereby effecting the execution of various trouble diagnostics. In one embodiment, the ticketing system 234 is in communications with the trouble diagnostics module 232.

In one embodiment, the trouble diagnostics module 232 is used to run diagnostics to detect protocol related troubles, circuit related troubles, and/or congestion related troubles. For example, the trouble diagnostics module may run various diagnostics in parallel or in series to detect whether the root cause is related to a protocol trouble, a circuit trouble and/or congestion. Note that the multiple diagnostics may uncover one or more root causes for a slow response.

In one embodiment, the trouble diagnostics module 232 may send a test packet to a router using a pre-selected protocol to determine if a slow response is due to the selected protocol. For example, if the router is supporting one or more protocols such as an IP protocol, a Novell protocol, an Apollo protocol, an Appletalk protocol, and the like, the trouble may be due to one of the protocols.

In one embodiment, the trouble diagnostics module 232 may then select one or more protocols, select a target IP address that is serviced by the router being tested, and then send test packets using the one or more selected protocols. The method then receives responses for the test packets and determines if one or more of the responses exceeded a pre-determined threshold. If the trouble is determined to be due to a protocol, the application server may take down the protocol for that router. The application server then notifies the service provider via the notification module 235.

In one embodiment, the trouble diagnostics module 232 may also acquire circuit related data from one or more routers to determine if a slow response is due to a circuit trouble, e.g., a degraded or a failed circuit. For example, the trouble diagnostics module gathers data from the routers servicing a circuit including but not limited to: a circuit down, unavailable second counts, Errored Second (ES) counts, code violations, slip seconds, bursty errored seconds, severely errored seconds, and/or degraded minutes in accordance with a network monitoring standard, e.g., an International Telecommunication Union (ITU) standard. In one embodiment, the gathered data may then be correlated to determine if the root cause is a circuit trouble. If the trouble is determined to be due to a circuit trouble, the application server may then notify the service provider via the notification module 235. The service provider may then initiate the pertinent remedial steps. For example, a routing path may be changed to avoid a degraded circuit. In another example, a switch to a protection circuit may be performed such that the degraded physical link may be repaired.

In one embodiment, the trouble diagnostics module 232 may also acquire bandwidth utilization data from the routers to determine if a slow response is due to congestion. For example, the actual traffic volume for a circuit may reach or exceed its predetermined bandwidth utilization level. For example, a circuit may have reached its Committed Information Rate (CIR) due to an increase in customer traffic. The application server may then notify the service provider and/or the customer via the notification module 235.

In one embodiment, if the trouble is determined to be due to congestion, the application server may increase the CIR for one or more routers to allow the routers to handle more traffic. For example, if the router had a CIR of 80%, it may be allowed to reach 95% to handle the increased traffic volume. In one embodiment, the remedial step may include upgrading the circuit to a higher bandwidth circuit. For example, the service provider may notify the customer that his/her traffic has exceeded the predetermined threshold. The customer may then upgrade the service to a higher capacity service.

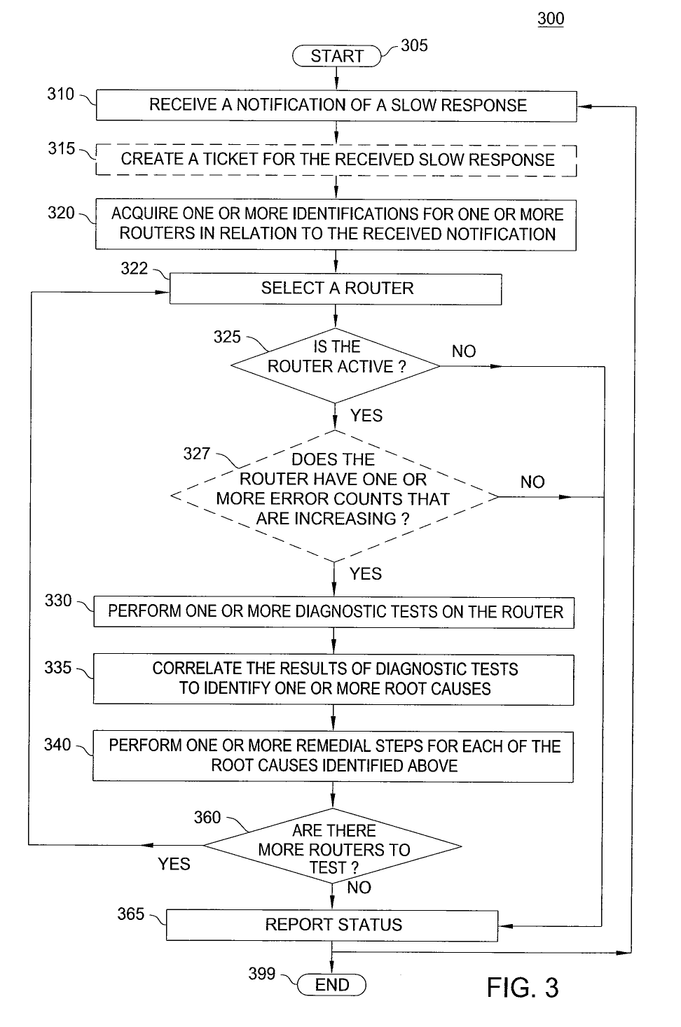

FIG. 3 illustrates a flowchart of a method 300 for providing detection and prevention of a slow response. Method 300 starts in step 305 and proceeds to step 310.

In step 310, method 300 receives a notification of a slow response. For example, a customer or a network monitoring module reports a slow response for an interface on a router. For example, latency for a response from a PE router may exceed a predetermined threshold.

In optional step 315, method 300 creates a ticket for the received slow response (if not already created). For example, a ticket may be needed to invoke one or more diagnostics on one or more routers that are supporting a service for a customer that reported the slow response.

In step 320, method 300 acquires one or more identifications for one or more routers in relation to the received notification. For example, the method acquires the identifications (names or addresses) of the routers that support the service for the customer who reported the slow response. For example, the method may retrieve the router identifications by accessing a provisioning database to determine the interfaces on various routers used to provide the service to the customer.

In step 322, method 300 selects a router. For example, the method identifies a router that has not been diagnosed in relation to the received notification of a slow response. The method then proceeds to step 325.

In step 325, method 300 determines if a router is active. For example, the method pings the router to determine if it is active. If a router is not active, the method proceeds to step 365 to report the status. Otherwise, the method proceeds to step 327.

In an optional step 327, method 300 determines if the router has one or more error counts that are increasing. For example, the method may retrieve data from error counters in the router in accordance with a predetermined number of times separated by a predetermined interval. For example, the method may retrieve data from the error counters, 3 times separated by 5 minute intervals. The data may then be analyzed to determine it the router has one or more error counts that are increasing. If there are one or more error counts that are increasing, the method proceeds to step 330. Otherwise, the method proceeds to step 365 to report the status.

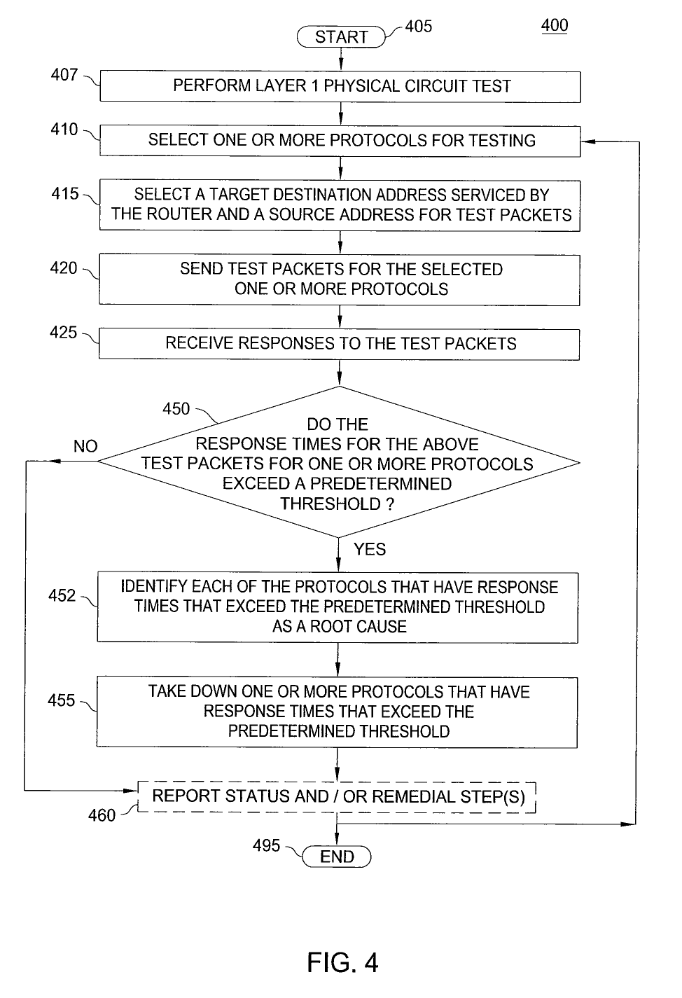

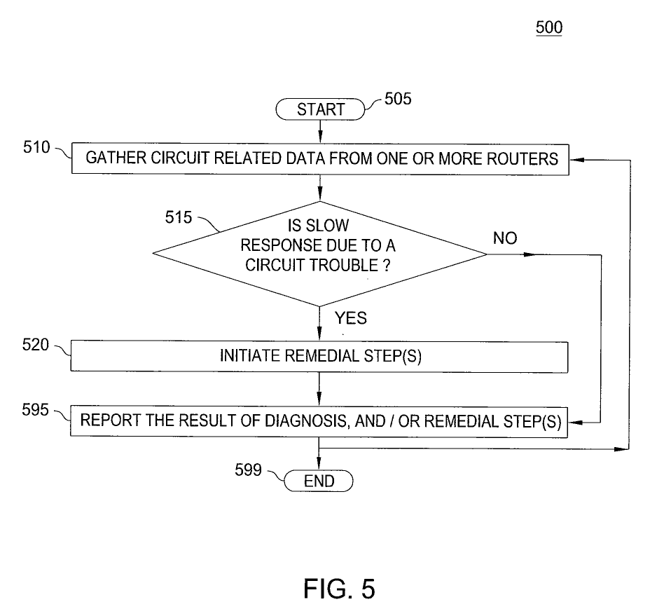

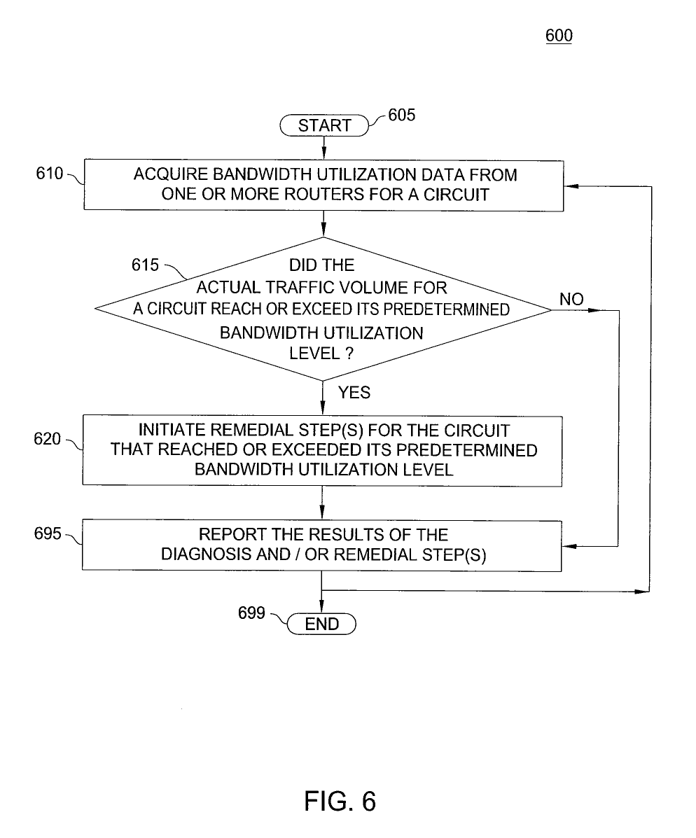

In step 330, method 300 performs one or more diagnostic tests on the router. For example, the method performs diagnostic tests on the router for identifying protocol troubles, congestion troubles and/or circuit troubles. For more details, FIG. 4 below illustrates a method for performing a protocol diagnostic test on a router. Similarly, FIG. 5 below illustrates a method for performing a circuit diagnostic test, and FIG. 6 below illustrates a method for performing a congestion diagnostic test.

In step 335, method 300 correlates the results of diagnostic tests to identify one or more root causes. For example, the method may identify a trouble related to a particular protocol. Note that the correlation may identify multiple root causes.

In step 340, method 300 performs one or more remedial steps for each of the root causes identified above. For example, if there is a congestion problem, the method may allow a router to have a higher committed information rate. That is, the utilization rate may be allowed to burst. If a protocol trouble is also detected, the method may take down the particular protocol for the router. If a circuit is degraded, the circuit may be switched to a protection mode such that a physical repair may be performed. Thus, the specific implementation of the remedial steps will depend on the uncovered root cause.

In step 360, method 300 determines if there are more routers to test. If there are more routers to be tested as identified in step 320 that have not been tested, the method proceeds to step 322 to select the next router. Otherwise, the method proceeds to step 365.

In step 365, method 300 reports the status. In one example, the method notifies the service provider if a ping to a router indicates an inactive router. In another example, the method notifies the service provider if the error counts in a router are stable and may not need further diagnosis. In another example, the method notifies the service provider of the one or more root causes that were responsible for the slow response and the remedial steps that were taken to address the uncovered or identified one or more root causes. Method 300 then ends in step 399 or returns to step 310 to receive new notifications.

FIG. 4 illustrates a flowchart of a method 400 for performing a protocol diagnostic test on a router. For example, one or more steps of method 400 can be implemented by a trouble diagnostics module. Method 400 starts in step 405 and proceeds to step 407.

In step 407, method 400 performs a layer 1 physical circuit test. For example, a physical connectivity test is performed to ensure that there is no problem attributable to the physical layer. The method then proceeds to step 410.

In step 410, method 400 selects one or more protocols for testing. For example, the router may support a variety of protocols, e.g., IP, Novell, Apollo, Appletalk, and so on. The method then selects one or more of the protocols for testing. In one embodiment, the method selects a protocol for testing based on a priority parameter, e.g., a high priority versus a lower priority and so on. For example, a protocol associated with a higher priority, e.g., for a VoIP call, versus a protocol associated with a lower priority, e.g., for an email, may be selected first and so on. For example, when performing protocol testing for slow responses, one could check the routers for QoS (Quality of Service). QoS may prioritize which protocols will have access to the bandwidth and at what percentage. A low priority protocol may not get access to the circuit due to higher priority protocols and will have high response times and/or dropped packets. Thus, a protocol diagnostic test can be tailored to account for priority of a particular protocol.

In step 415, method 400 selects a target destination address serviced by the router and a source address for the test packets. For example, an IP address for sending the test traffic may be selected among addresses supported by the router. The source address may be selected to use a source address close to the customer. For example, the service provider may be able to send the test traffic from a variety of locations.

In step 420, method 400 sends test packets for the selected one or more protocols. For example, the method sends test packets to the target destination address selected above using the selected protocols. The method then proceeds to step 425.

In step 425, method 400 receives responses to the test packets. For example, the method receives responses to all packets. The method then proceeds to step 450.

In step 450, method 400 determines if the response times for the above test packets for one or more protocols exceed a predetermined threshold for response time. For example, the application server may receive the responses with various response times, e.g., 150 ms response time for IP protocol and 50 ms response time for Novell protocol. If the threshold for response time is set to 80 ms, then the method determines that the IP protocol response time exceeds the predetermined threshold. If the response times for one or more test packets exceed the predetermined threshold, the method proceeds to step 452. Otherwise, the method proceeds to step 460.

In step 452, method 400 identifies each of the tested one or more protocols that has its response times exceeding the predetermined threshold as a root cause. For the example above, the IP protocol is identified as a root cause.

In step 455, method 400 takes down one or more protocols that have response times that exceed the predetermined threshold for the response time. For the above example, the application server takes down the IP protocol for the selected router. For example, the slow response may be due to the protocols with response times that exceed the predetermined threshold. The method then proceeds to step 460.

In optional step 460, method 400 reports the status and/or one or more remedial steps that have been taken. In one example, the method reports that a trouble with one or more protocols is detected. In another example, the method may also report to the service provider if a protocol is taken down. In another example, the method reports no thresholds were exceeded with respect to any of the selected protocols. The method then ends in step 495 or returns to step 410 to select another protocol for testing.

FIG. 5 illustrates a flowchart of a method 500 for performing a circuit trouble diagnostics test (broadly a circuit diagnostic test). For example, one or more steps of method 500 can be implemented by a trouble diagnostics module. Method 500 starts in step 505 and proceeds to step 510.

In step 510, method 500 gathers circuit related data from one or more routers. For example, the trouble diagnostics module gathers data from routers servicing a circuit including but not limited to: a circuit down, unavailable second counts, Errored Second (ES) counts, code violations, slip seconds, bursty errored seconds, severely errored seconds, and/or degraded minutes in accordance with a network monitoring standard, e.g., an International Telecommunication Union (ITU) standard.

In step 515, method 500 correlates gathered data and determines if the slow response is due to a circuit trouble. For example, the circuit may be degraded. If the slow response is determined to be due to a circuit trouble, the method proceeds to step 520. Otherwise, the method proceeds to step 595.

In step 520, method 500 initiates one or more remedial steps. In one embodiment, a routing path is changed to avoid the circuit with trouble. For example, a routing path may be changed to avoid a degraded circuit. In another embodiment, a switch to a protection circuit is performed such that the circuit with trouble and/or its physical link can be repaired. The method then proceeds to step 595.

In step 595, method 500 reports the result of the diagnosis and/or one or more remedial steps taken to address the detected circuit trouble. The method then ends in step 599 or returns to step 510 to continue gathering data.

FIG. 6 illustrates a flowchart of a method 600 for performing a congestion trouble diagnostics test (broadly a congestion diagnostic test). For example, one or more steps of method 600 can be implemented by a trouble diagnostics module. Method 600 starts in step 605 and proceeds to step 610.

In step 610, method 600 acquires bandwidth utilization data from one or more routers for a circuit. For example, the routers may contain real time counters for tracking discarded packets, thereby allowing the routers to provide congestion notifications, such as bandwidth utilization levels.

In step 615, method 600 determines if the actual traffic volume for a circuit reached or exceeded its predetermined bandwidth utilization level. For example, a circuit may have reached its Committed Information Rate (CIR) due to an increase in customer traffic. If the actual traffic volume for a circuit reached or exceeded its predetermined bandwidth utilization level, the method proceeds to step 620. Otherwise, the method proceeds to step 695.

In step 620, method 600 initiates one or more remedial steps for the circuit that reached or exceeded its predetermined bandwidth utilization level. In one embodiment, the remedial step may encompass increasing the CIR for one or more routers to allow the routers to handle more traffic. For example, if the router had a CIR of 80%, it may be allowed to reach 95% to handle the traffic volume. In one embodiment, the remedial step may encompass upgrading the circuit to a higher bandwidth circuit. For example, the service provider may notify the customer that his/her traffic has exceeded the predetermined threshold. The customer may then upgrade the service to a higher capacity service. The method then proceeds to step 695.

In step 695, method 600 reports the results of the diagnosis and/or one or more remedial steps that were taken to address the detected congestion trouble. For example, the method may report that the CIR is increased, or the actual traffic volumes for one or more customers are in excess of their respective CIRs. The method then ends in step 699 or returns to step 610 to continue acquiring data.

One aspect of the present invention is that the various steps and/or methods as discussed above can be performed in an automated fashion. In other words, once a slow response has been reported, the present invention can be implemented in an automated fashion to address the reported slow response, e.g., as reported in a ticket. This allows the present invention to quickly identify a root cause and to apply one or remedial steps in an automated fashion, thereby addressing a slow response problem that may impact the service provided by a network service provider to its customers.

It should be noted that although not specifically specified, one or more steps of methods 300, 400, 500 or 600 may include a storing, displaying and/or outputting step as required for a particular application. In other words, any data, records, fields, and/or intermediate results discussed in the method can be stored, displayed and/or outputted to another device as required for a particular application. Furthermore, steps or blocks in FIG. 3, 4, 5 or 6 that recite a determining operation or involve a decision, do not necessarily require that both branches of the determining operation be practiced. In other words, one of the branches of the determining operation can be deemed as an optional step.

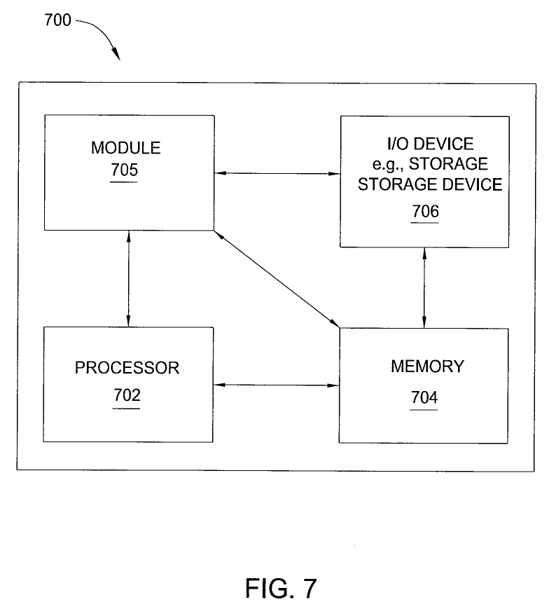

FIG. 7 depicts a high-level block diagram of a general-purpose computer suitable for use in performing the functions described herein. As depicted in FIG. 7, the system 700 comprises a processor element 702 (e.g., a CPU), a memory 704, e.g., random access memory (RAM) and/or read only memory (ROM), a module 705 for providing detection and prevention of a slow response on networks, and various input/output devices 706 (e.g., storage devices, including but not limited to, a tape drive, a floppy drive, a hard disk drive or a compact disk drive, a receiver, a transmitter, a speaker, a display, a speech synthesizer, an output port, and a user input device (such as a keyboard, a keypad, a mouse, and the like)).

It should be noted that the present invention can be implemented in software and/or in a combination of software and hardware, e.g., using application specific integrated circuits (ASIC), a general purpose computer or any other hardware equivalents. In one embodiment, the present module or process 705 for providing detection and prevention of a slow response on networks can be loaded into memory 704 and executed by processor 702 to implement the functions as discussed above. As such, the present method 705 for providing detection and prevention of a slow response on networks (including associated data structures) of the present invention can be stored on a computer readable medium, e.g., RAM memory, magnetic or optical drive or diskette and the like.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for testing a router, comprising:
selecting a router automatically for testing in response to a ticket indicating a slow response;
performing a diagnostic test on said router, wherein said diagnostic test comprises at least one of: a protocol diagnostic test, a circuit diagnostic test or, a congestion diagnostic test; and
performing at least one remedial step to address a root cause that is identified by said diagnostic test, wherein said root cause is associated with said slow response.

2. The method of claim 1, wherein said protocol diagnostic test comprises:
selecting one or more protocols;
selecting a target destination address serviced by said router and a source address for sourcing a plurality test packets;
sending said plurality of test packets for said one or more protocols from said source address to said target destination address;
receiving responses to said plurality of test packets;
determining if a response time for said plurality of packets has exceeded a predetermined threshold; and
identifying each of said one or more protocols that has its corresponding response time exceeding said predetermined threshold as said root cause.

3. The method of claim 2, wherein said at least one remedial step comprises taking down each of said one or more protocols that has been identified as said root cause.

4. The method of claim 3, wherein said at least one remedial step is performed automatically.

5. The method of claim 1, wherein said at least one remedial step comprises changing a routing path to avoid a circuit identified as a trouble circuit, or switching to a protection circuit so that said circuit identified as a trouble circuit is repaired.

6. The method of claim 5, wherein said at least one remedial step is performed automatically.

7. The method of claim 1, wherein said at least one remedial step comprises increasing a Committed Information Rate (CIR) for said router or upgrading a circuit to a higher bandwidth circuit.

8. The method of claim 7, wherein said at least one remedial step is performed automatically.

9. The method of claim 1, further comprising:
determining if said router has an error count that is increasing, wherein said diagnostic test is only performed if said error count is determined to be increasing.

10. A computer-readable medium having stored thereon a plurality of instructions, the plurality of instructions including instructions which, when executed by a processor, cause the processor to perform steps of a method for testing a router, comprising:
selecting a router automatically for testing in response to a ticket indicating a slow response;
performing a diagnostic test on said router, wherein said diagnostic test comprises at least one of: a protocol diagnostic test, a circuit diagnostic test or, a congestion diagnostic test; and
performing at least one remedial step to address a root cause that is identified by said diagnostic test, wherein said root cause is associated with said slow response.

11. The computer-readable medium of claim 10, wherein said protocol diagnostic test comprises:
selecting one or more protocols;
selecting a target destination address serviced by said router and a source address for sourcing a plurality test packets;
sending said plurality of test packets for said one or more protocols from said source address to said target destination address;
receiving responses to said plurality of test packets;
determining if a response time for said plurality of packets has exceeded a predetermined threshold; and
identifying each of said one or more protocols that has its corresponding response time exceeding said predetermined threshold as said root cause.

12. The computer-readable medium of claim 11, wherein said at least one remedial step comprises taking down each of said one or more protocols that has been identified as said root cause.

13. The computer-readable medium of claim 12, wherein said at least one remedial step is performed automatically.

14. The computer-readable medium of claim 10, wherein said at least one remedial step comprises changing a routing path to avoid a circuit identified as a trouble circuit, or switching to a protection circuit so that said circuit identified as a trouble circuit is repaired.

15. The computer-readable medium of claim 14, wherein said at least one remedial step is performed automatically.

16. The computer-readable medium of claim 10, wherein said at least one remedial step comprises increasing a Committed Information Rate (CIR) for said router or upgrading a circuit to a higher bandwidth circuit.

17. The computer-readable medium of claim 16, wherein said at least one remedial step is performed automatically.

18. The computer-readable medium of claim 10, further comprising:
determining if said router has an error count that is increasing, wherein said diagnostic test is only performed if said error count is determined to be increasing.

19. An apparatus for testing a router, comprising:
means for selecting a router automatically for testing in response to a ticket indicating a slow response;
means for performing a diagnostic test on said router, wherein said diagnostic test comprises at least one of: a protocol diagnostic test, a circuit diagnostic test or, a congestion diagnostic test; and
means for performing at least one remedial step to address a root cause that is identified by said diagnostic test, wherein said root cause is associated with said slow response.

20. The apparatus of claim 19, wherein said protocol diagnostic test comprises:
selecting one or more protocols;
selecting a target destination address serviced by said router and a source address for sourcing a plurality test packets;
sending said plurality of test packets for said one or more protocols from said source address to said target destination address;
receiving responses to said plurality of test packets;
determining if a response time for said plurality of packets has exceeded a predetermined threshold; and
identifying each of said one or more protocols that has its corresponding response time exceeding said predetermined threshold as said root cause.
